(19) United States
(12) Patent Application Publication
(10) Pub. No.: US 2015/0261282 A1
(43) Pub. Date: Sep. 17, 2015

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Mitsugu Yamauchi, Kawasaki-shi (JP)

(21) Appl. No.: 14/634,951

(22) Filed: Mar. 2, 2015

(30) Foreign Application Priority Data
Mar. 13, 2014 (JP) 2014-050531

(51) Int. Cl. G06F 1/32

(52) U.S. Cl. CPC G06F 1/3234

(57) ABSTRACT

There are provided an information processing apparatus having a power saving function of reducing power consumption, and a method of controlling the information processing apparatus. It is determined whether a communication partner apparatus supports the power saving function. If it is determined that the communication partner apparatus does not support the power saving function, the user is prompted to set an operation mode. Communication with the communication partner apparatus is then established according to the set operation mode.

### BACKGROUND OF THE INVENTION

1. Field of the Invention

The present invention relates to an information processing apparatus, a method of controlling the same, and a storage medium.

2. Description of the Related Art

In recent years, along with an increase in communication speed of a network, the power consumption of the network communication unit of an information processing apparatus which is connected to the network and performs communication also increases. As a technique of reducing the power consumption, there is proposed a technique in which if no communication has been performed in a network communication unit for a predetermined time period, the power consumption of the network communication unit is reduced while maintaining network connection. An example of this technique is an EEE (Energy Efficient Ethernet). In the EEE, upon detecting an idle state in which no network communication is performed for a predetermined time period, the power consumption of a network communication unit is reduced by transiting to a low power idle (to be referred to as an LPI hereinafter) in which the power consumption is lower than that in a normal operation. Such method of reducing the power consumption is called an LPI method. This power saving function is enabled when both an information processing apparatus and a connection destination apparatus support the power saving function.

In general, when establishing network communication, information indicating whether both an information processing apparatus and a connection destination apparatus support the above-described power saving function is obtained by auto negotiation. If both the apparatuses support the power saving function, it is possible to transit to the LPI upon detecting the above-described idle state. To the contrary, if it is determined in the auto negotiation that the connection destination apparatus does not support the power saving function, the information processing apparatus cannot transit to the LPI. In this case, therefore, even if no network communication has been performed for the predetermined time period or more, it is impossible to transit to the LPI in which the power consumption is reduced.

To cope with this, there is provided the following technique as a technique of reducing the power consumption of the network communication unit even if the connection destination apparatus does not support the power saving function. That is, if it is determined that the connection destination apparatus does not support the power saving function, communication is performed by setting a communication speed to be lower than a highest communication speed at which communication with the connection destination is possible (see, for example, Japanese Patent Laid-Open No. 2013-27991). For example, assume that the highest communication speed between the information processing apparatus and the connection destination apparatus is 1 Gbps. In this case, if it is determined that the connection destination apparatus does not support the power saving function, when a condition for transiting to the LPI is satisfied, communication is performed by setting the communication speed to a lower speed of 100 Mbps. This can reduce the power consumption of the network communication unit to be lower than that for the highest communication speed.

In the above conventional technique, however, if the connection destination apparatus does not support the above-described power saving function, the communication speed is unwantedly fixed to that lower than the highest communication speed at which communication is possible. Since, however, some users may want to prioritize communication at the highest communication speed over reduction of the power consumption, fixing the communication speed to a lower one for power saving impairs the user convenience.

### SUMMARY OF THE INVENTION

An aspect of the present invention is to eliminate the above-mentioned problems with conventional technology.

A feature of the present invention is to provide a technique which is able to control the power consumption according to user settings even if a partner apparatus as a connection destination apparatus does not support the power saving function.

The present invention in its first aspect provides an information processing apparatus having a power saving function for reducing power consumption, comprising: a determination unit configured to determine whether a communication partner apparatus supports the power saving function; a setting unit configured to, if the determination unit determines that the communication partner apparatus does not support the power saving function, prompt a user to set an operation mode; and a communication unit configured to perform communication by establishing communication with the communication partner apparatus according to the operation mode set by the setting unit.

The present invention in its second aspect provides an information processing apparatus comprising: a first setting unit configured to prompt a user to enable or disable a power saving function of the information processing apparatus; a second setting unit configured to, if the power saving function of the information processing apparatus is enabled, prompt the user to set a communication speed when a communication partner apparatus does not support the power saving function; and a communication unit configured to, if the communication partner apparatus does not support the power saving function, perform communication by establishing communication with the communication partner apparatus according to the communication speed set by the second setting unit.

The present invention in its third aspect provides a method of controlling an information processing apparatus having a power saving function for reducing power consumption, the method comprising: determining whether a communication partner apparatus supports the power saving function; if it is determined in the determining that the communication partner apparatus does not support the power saving function, prompting a user to set an operation mode; and performing communication by establishing communication with the communication partner apparatus according to the operation mode set by the user.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining the hardware arrangement of an information processing apparatus according to a first embodiment of the present invention;

FIG. 2 is a block diagram showing an example of the connection form of the information processing apparatus according to the first embodiment;

FIG. 3 is a flowchart for describing an operation until network communication is established between the information processing apparatus and a HUB according to the first embodiment;

FIG. 4 depicts a view showing an example of a user setting screen displayed on a touch panel of a console unit of the information processing apparatus according to the first embodiment;

FIG. 5 is a sequence chart for explaining an example of exchange between a PHY and a MAC in an operation of transiting to the LPI and canceling the LPI when the LPI function is enabled in the information processing apparatus according to the first embodiment;

FIG. 6 depicts a view showing an example of a network mode selection screen displayed on the touch panel of the information processing apparatus according to the first embodiment;

FIG. 7 is a flowchart for describing EEE setting processing by an information processing apparatus according to a second embodiment;

FIGS. 8A to 8D depict views showing various screen examples which are displayed on the touch panel of the information processing apparatus when performing Ethernet driver setting and EEE-related setting according to the second embodiment;

FIG. 9 is a flowchart for describing processing until the information processing apparatus establishes network communication according to the second embodiment;

FIG. 10 is a flowchart for describing an operation in which an information processing apparatus establishes network communication with a HUB, and notifying that the EEE is not supported according to a third embodiment; and

FIG. 11 depicts a view showing an example of a screen for notifying that a network connection destination apparatus does not support the EEE according to the third embodiment.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

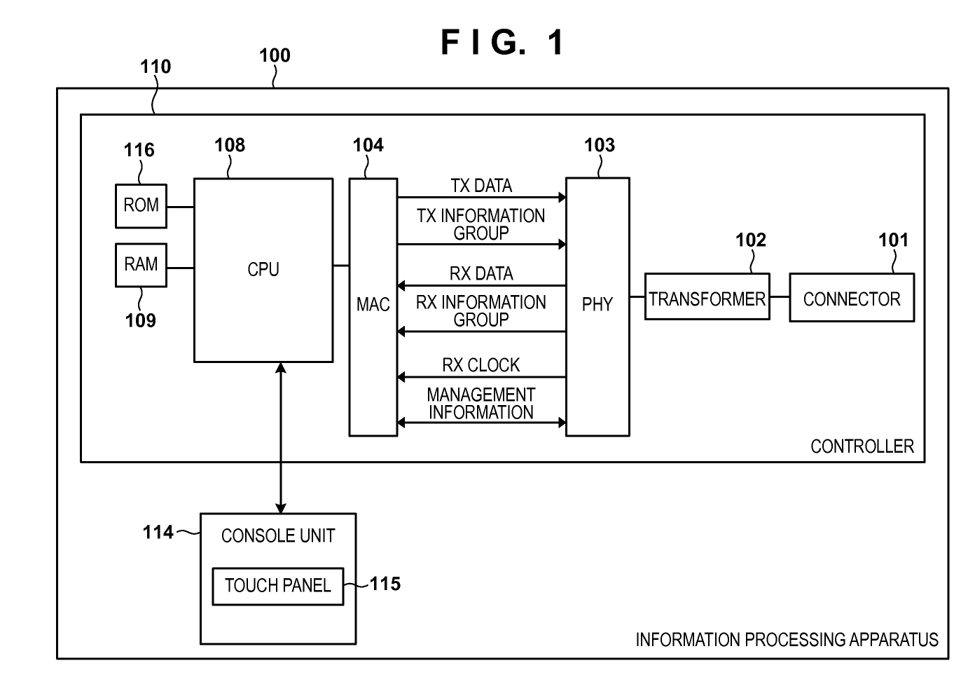

FIG. 1 is a block diagram for explaining the hardware arrangement of an information processing apparatus 100 according to a first embodiment of the present invention.

A controller 110 controls the overall operation of the information processing apparatus 100. A connector 101 connects this information processing apparatus 100 to a LAN cable forming a network. A transformer 102 electrically isolates the information processing apparatus 100 from the network. A PHY (physical layer) 103 is a physical layer which exchanges electrical signals with a connection destination apparatus via the network in the information processing apparatus 100. The PHY 103 according to this embodiment is communicable at a communication speed of 1 Gbps, 100 Mbps, or 10 Mbps. A MAC (Media Access Control) 104 converts a signal received by the PHY 103 into a frame to be processed by a unit of the information processing apparatus. A CPU 108 controls the operation of this apparatus by deploying a program stored in a ROM 116 into a RAM 109, and executing it. The RAM 109 provides a work area at the time of execution of processing by the CPU 108, and temporarily stores a program and various data. The ROM 116 stores programs to be executed by the CPU 108, and stores setting values, initial data, and the like of the information processing apparatus 100. A console unit 114 displays a message from the information processing apparatus 100 to the user, and the like, and accepts an input of a user operation. The console unit 114 includes a touch panel 115. The touch panel 115 displays information from the information processing apparatus 100 to the user, and an operation screen to be operated by the user. The user can input various kinds of information to the information processing apparatus 100 by pressing various buttons (not shown) of the operation screen displayed on the screen of the touch panel 115.

Signals between the MAC 104 and the PHY 103 will now be explained.

TX data indicates transmission data transmitted from the MAC 104 to the PHY 103, and a TX information group indicates the transmission state of the transmission data (TX data) from the MAC 104 to the PHY 103. The TX information group includes a transmission enable state and transmission error state from the MAC 104. RX data indicates reception data received by the MAC 104 from the PHY 103, and an RX information group indicates the state of the reception data (RX data) received by the MAC 104 from the PHY 103. The RX information group includes a reception data detection state and reception data error information. An RX clock is that synchronized with the RX data received by the MAC 104 from the PHY 103. Management information is bidirectionally exchanged between the PHY 103 and the MAC 104.

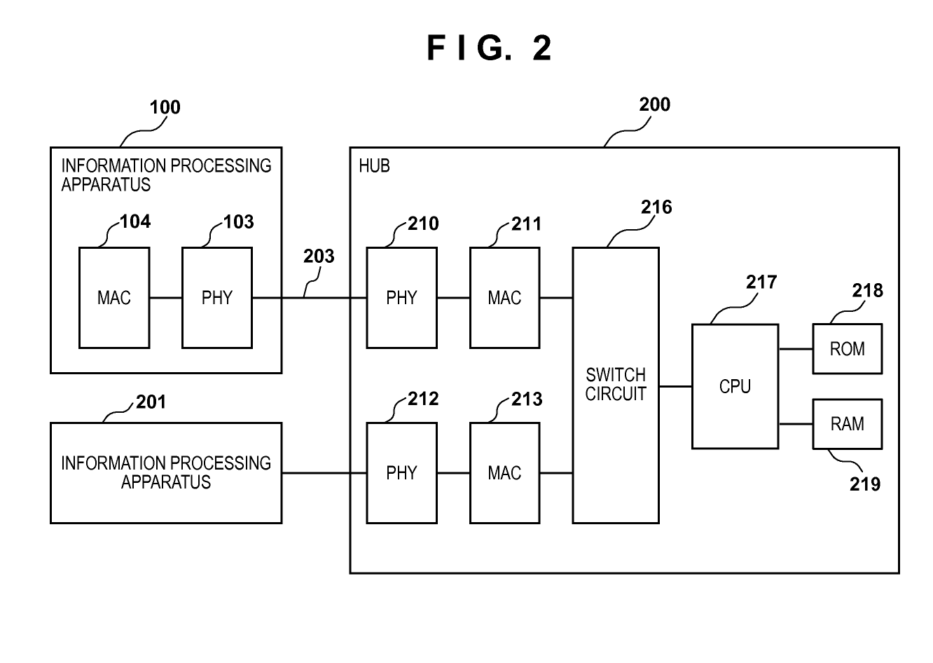

FIG. 2 is a block diagram showing an example of the connection form of the information processing apparatus 100 according to the first embodiment. Referring to FIG. 2, the information processing apparatus 100 is the information processing apparatus described with reference to FIG. 1. However, the components other than the PHY 103 and MAC 104 are omitted for the sake of descriptive convenience.

A HUB 200 can be connected to a plurality of apparatuses via a network, and perform packet exchange and packet broadcast transfer. A PHY 210 is used by the HUB 200 to be connected to another apparatus via the network, and has the same functions as those of the PHY 103. In the first embodiment, assume that the PHY 210 is connected to the PHY 103 of the information processing apparatus 100 via a network cable 203. A MAC 211 is that incorporated in the HUB 200, and has the same functions as those of the MAC 104. An information processing apparatus 201 communicates data with the information processing apparatus 100 via the HUB 200. A PHY 212 is that used to be connected to the information processing apparatus 201, and has same functions as those of the PHY 103. A MAC 213 is that connected to the PHY 212, and has the same functions as those of the MAC 104. In the first embodiment, the PHYs 210 and 212 can operate at a communication speed of 1 Gbps, 100 Mbps, or 10 Mbps. The network cable 203 connects the information processing apparatus 100 and the HUB 200.

Strictly speaking, the PHY 103 of the information processing apparatus 100 is connected to the HUB 200 via the connector 101 and the transformer 102. However, in FIG. 2, the connector 101 and the transformer 102 are omitted. For the sake of descriptive convenience, a description of the connector 101 and transformer 102 will be omitted in the following description. The PHYs 210 and 212 of the HUB 200 are connected to the information processing apparatuses 100 and 201 via connectors, transformers and network cables, respectively, similarly to the PHY 103 of the information processing apparatus 100. The connectors and transformers are not shown in FIG. 2 for the sake of descriptive convenience.

A switch circuit 216 has a function of transferring packets received via the MACs 211 and 213 in a predetermined direction. A CPU 217 controls the operation of the HUB 200. A ROM 218 stores programs to be executed by the CPU 217, and stores setting values, initial data, and the like of the HUB 200. A RAM 219 temporarily stores a program to be executed by the CPU 217, and provides a work area for storing various data when the CPU 217 executes processing.

Note that in FIG. 2, the HUB 200 is connected to only the two information processing apparatuses 100 and 201 for the sake of descriptive convenience. However, the HUB 200 may further include a plurality of PHYs and a plurality of MACs, and can be connected to a plurality of apparatuses other than the information processing apparatuses 100 and 201.

In the first embodiment, assume that the PHY 103 of the information processing apparatus 100 supports the LPI (Low Power Idle) method of the EEE (Energy Efficient Ethernet). In the EEE, upon detecting an idle state in which no network communication has been performed for a predetermined time period, transition to the LPI in which the power consumption is lower than that in the normal operation is performed. More specifically, if the PHY 103 transmits/receives no packets for a given time period, some of the functions of the PHY 103 and MAC 104 are stopped to reduce the power consumption of the PHY 103 and MAC 104. In the LPI, the PHY 103 does not change the communication speed, and the link of the network is not disconnected. To reduce the power consumption by the LPI method, the PHY 210 as the connection destination of the PHY 103 needs to have the power saving function by the LPI method, similarly to the PHY 103.

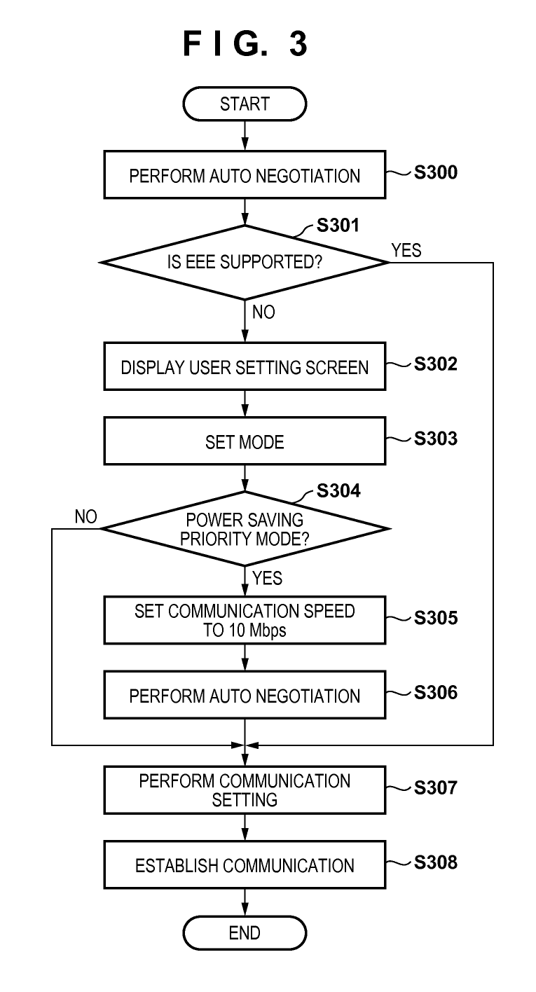

FIG. 3 is a flowchart for describing an operation until the information processing apparatus 100 establishes network communication with the HUB 200 according to the first embodiment. A program for executing processing shown in the flowchart is stored in the ROM 116, deployed into the RAM 109 at the time of execution, and executed under the control of the CPU 108.

This processing starts when a user turns on the power switch (not shown) of the information processing apparatus 100, power is supplied to the information processing apparatus 100, power is supplied to the controller 110 and its respective units, and thus the apparatus is activated. After activation, the information processing apparatus 100 starts an operation of establishing network communication. Note that the operation of establishing network communication is performed not only at the time of activation of the information processing apparatus 100 but also at the time of reactivation of the information processing apparatus 100, activation and reactivation of the HUB 200, and connection of the network cable 203.

When the processing of establishing network communication starts in this way, the CPU 108 controls the PHY 103 via the MAC 104 to execute auto negotiation in step S300. In this auto negotiation, the information processing apparatus 100 and the HUB 200 as a connection partner notify one another of the communication speed and information about full-duplex/half-duplex, and acquire these pieces of information from one another. Furthermore, in this auto negotiation, the information processing apparatus 100 and the HUB 200 as a connection partner exchange information indicating whether the self apparatus supports the EEE or not. In the first embodiment, the PHY 103 of the controller 110 sends and obtains the communication speed, the information about full-duplex/half-duplex, and the information indicating support/non-support of the EEE. The CPU 108 controls the PHY 103 via the MAC 104 to send and obtain these pieces of information. Similarly, in the HUB 200, the CPU 217 controls the PHY 210 via the switch circuit 216 and MAC 211 to send and obtain these pieces of information.

The process advances to step S301, and the CPU 108 determines whether the HUB 200 as a connection partner supports the EEE. In this example, the CPU 108 makes determination based on the information indicating support/non-support of the EEE of the HUB 200, which has been obtained in the auto negotiation in step S300.

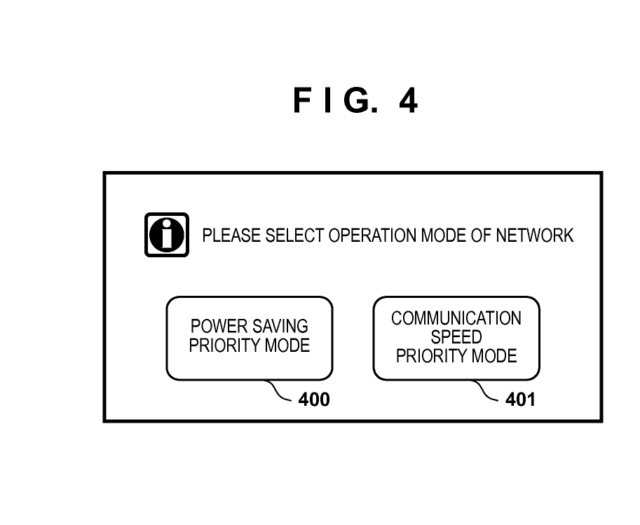

An operation when it is determined that the HUB 200 does not support the EEE will be described. In this case, the process advances to step S302, and the CPU 108 displays a user setting screen shown in FIG. 4 on the touch panel 115 of the console unit 114.

FIG. 4 depicts a view showing an example of the user setting screen displayed on the touch panel 115 of the console unit 114 of the information processing apparatus 100 according to the first embodiment.

The screen shown in FIG. 4 is used to prompt the user to set the operation mode of the network. In this screen, the user can select one of a “power saving priority mode” of prioritizing power saving and a “communication speed priority mode” of prioritizing the communication speed. If the user wants to operate the information processing apparatus 100 by prioritizing power saving over the communication speed, he/she presses a power saving priority mode button 400 displayed on the screen. This sets the information processing apparatus 100 in the power saving priority mode. On the other hand, if the user wants to operate the information processing apparatus 100 by prioritizing the communication speed over power saving, he/she presses a communication speed priority mode button 401. This sets the information processing apparatus 100 in the communication speed priority mode. Therefore, in step S303, the CPU 108 sets the information processing apparatus 100 in the power saving priority mode or communication speed priority mode in accordance with the button pressed by the user on the user setting screen displayed on the touch panel 115.

The process advances to step S304, and the CPU 108 determines which one of the power saving priority mode and the communication speed priority mode has been set. If it is determined that the user has pressed the power saving priority mode button 400 to set the apparatus in the power saving priority mode, the process advances to step S305. In step S305, the CPU 108 controls the PHY 103 via the MAC 104 to set the communication speed of the PHY 103 to 10 Mbps, and advances the process to step S306. In other words, in step S305, valid settings of 1 Gbps and 100 Mbps of the PHY 103 are disabled, and only a setting of a lowest speed of 10 Mbps is enabled. In step S306, the CPU 108 requests the HUB 200 to perform auto negotiation again since the communication speed of the PHY 103 has been changed. In this auto negotiation in step S306, the information processing apparatus 100 and the HUB 200 exchange the communication speeds, pieces of information about full-duplex/half-duplex, and pieces of information indicating support/non-support of the EEE. In this example, as described above, since the settings of 1 Gbps and 100 Mbps of the PHY 103 have been disabled, the information processing apparatus 100 notifies the HUB 200 that a supportable communication speed is 10 Mbps. As a result, the communication speed of the PHY 103 is decided as 10 Mbps. As for full-duplex/half-duplex, when one of the information processing apparatus 100 and the HUB 200 supports half-duplex, half-duplex is decided for both the information processing apparatus 100 and the HUB 200. As for support/non-support of the EEE, since the HUB 200 does not support the EEE as described above, non-support of the EEE is decided. Upon completion of the auto negotiation, the process advances to step S307.

In step S307, the CPU 108 performs communication setting of the PHY 103 via the MAC 104. In this communication setting, the communication speed, full-duplex/half-duplex, support/non-support of the EEE, and the like which have been decided by the auto negotiation in step S306 are set in the PHY 103. As described above, since the HUB 200 does not support the EEE, the PHY 103 is set in a normal mode in which it is impossible to reduce the power consumption even if network communication is in the idle state. The CPU 217 of the HUB 200 sets the communication speed of the PHY 210 to 10 Mbps via the switch circuit 216 and MAC 211, and reflects the result of the auto negotiation in the setting with respect to full-duplex/half-duplex. Upon completion of the communication setting in step S307, the process advances to step S308, and the CPU 108 establishes communication with the HUB 200, thereby terminating the process.

On the other hand, if the CPU 108 determines in step S304 that the communication speed priority mode has been set, the process advances to step S307 to perform communication setting without setting the communication speed in step S305 or performing auto negotiation in step S306. In this communication setting, the communication speed, full-duplex/half-duplex, and support/non-support of the EEE which have been decided based on the result of the auto negotiation in step S300 are set in the PHY 103. As for support/non-support of the EEE, the CPU 108 sets the PHY 103 in the normal mode in the same way as described above. The communication speed of the PHY 103 is set to the highest communication speed of the HUB 200 obtained in the auto negotiation in step S300. In the first embodiment, the PHY 210 of the HUB 200 is operable at a communication speed of 1 Gbps, 100 Mbps, or 10 Mbps. Therefore, the CPU 108 sets the communication speed of the PHY 103 to the highest communication speed of 1 Gbps. As for full-duplex/half-duplex, the result of the auto negotiation in step S300 is reflected in the setting in the same way as described above. Upon completion of the communication setting in step S307, the process advances to step S308, and communication between the information processing apparatus 100 and the HUB 200 is established, thereby terminating the process.

An operation when it is determined in step S301 that the HUB 200 supports the EEE will be described. In this case, the process advances to step S307, and the CPU 108 performs communication setting. As for support/non-support of the EEE, since the HUB 200 supports the EEE, when the PHY 103 enters an idle state in which no network communication has been performed for a predetermined time period, the CPU 108 sets the PHY 103 to enable the LPI function of reducing the power consumption. As for the communication speed and full-duplex/half-duplex, the result of the auto negotiation is reflected in the settings of the PHY 103 in the same way as described above. Upon completion of the communication setting in step S307, the process advances to step S308 to establish communication between the information processing apparatus 100 and the HUB 200, thereby terminating the process. In this case, if the condition for transiting to the LPI, for example, the condition that no network communication is executed during the predetermined time period is satisfied, the information processing apparatus 100 is able to transit to the LPI in which the power consumption is reduced.

As described above, if the connection destination apparatus supports the EEE, when the condition for transiting to the LPI is satisfied, it is possible to transit to the LPI to suppress the power consumption. Alternatively, if the connection destination apparatus does not support the EEE, the user can set to prioritize one of power saving and the communication speed. If the user sets to prioritize power saving, it is possible to suppress the power consumption by decreasing the communication speed of the PHY. On the other hand, if the user sets to prioritize the communication speed, it is possible to perform high-speed communication by setting the communication speed of the PHY to the possible highest communication speed.

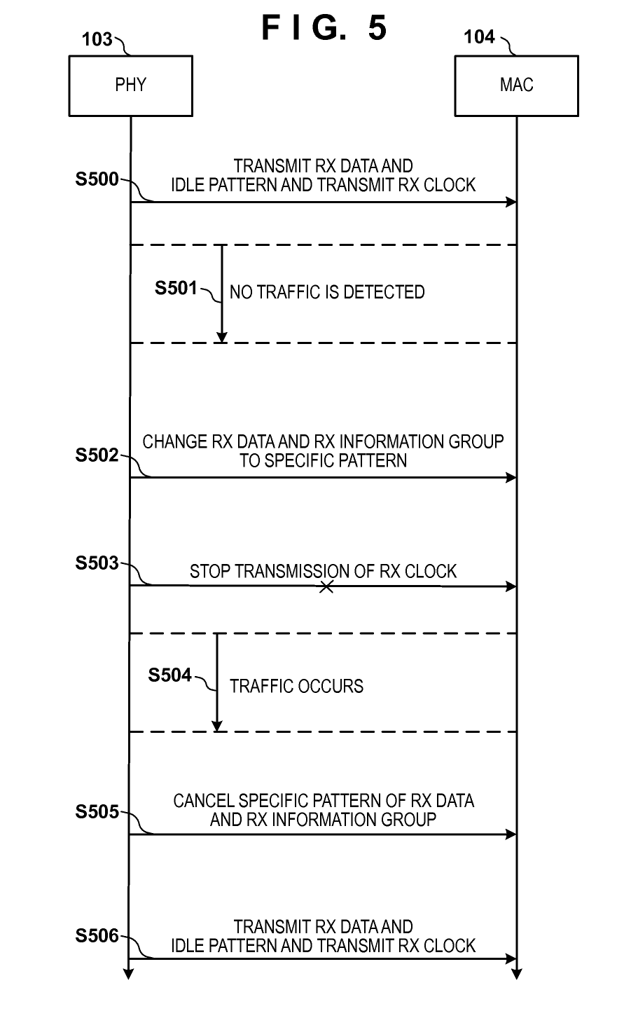

An operation of transiting to the LPI and an operation of canceling the LPI in the information processing apparatus 100 according to the first embodiment will be described with reference to FIG. 5.

FIG. 5 is a sequence chart for explaining an example of exchange between the PHY 103 and the MAC 104 in an operation of transiting to the LPI and canceling the LPI when the LPI function is enabled in the information processing apparatus 100 according to the first embodiment.

In S500, after network communication is established and before transition to the LPI is performed, the PHY 103 transmits signals to the MAC 104. At this time, the PHY 103 transmits, by RX data, an idle pattern in which electrical High and Low levels alternately change. The PHY 103 also transmits an RX clock.

In S501, the PHY 103 detects the absence of traffic indicating that there is no data communication (to be referred to as traffic hereinafter) for a predetermined time period, and the condition for transiting to the LPI is satisfied.

In S502, the PHY 103 notifies the MAC 104 that a state in which transition to the LPI is possible has been detected, by changing the RX data and RX information group to a specific pattern. In response to this notification, the MAC 104 transits to the LPI. After that, in S503, the PHY 103 stops transmission of the RX clock. By stopping transmission of the RX clock, it is possible to reduce the power consumption of a portion of the MAC 104 which operates in synchronism with the RX clock. In S504, traffic occurs in the LPI, so the PHY 103 detects cancellation of the LPI transition condition (returning to the normal operation mode). In S505, the PHY 103 cancels transmission of the specific pattern of the RX data and RX information group, thereby notifying the MAC 104 that the state in which transition to the LPI is possible has been canceled (the PHY 103 has returned from the LPI to the normal mode). In response to the notification, the MAC 104 cancels the LPI (returns to the normal mode). After that, in S506, the PHY 103 starts transmitting, by RX data, an idle pattern in which electrical High and Low levels alternately change. In S506, the PHY 103 also re-starts transmitting the RX clock.

Exchange between the PHY 103 and the MAC 104 when performing an operation of transiting to the LPI and returning from the LPI has been explained. When the LPI function is enabled, this exchange shown in FIG. 5 is repeated in accordance with traffic occurring on the network. More specifically, after S506, if the PHY 103 detects the absence of traffic again for the predetermined time period, the sequence returns to the state in S502. If traffic occurs again, the sequence returns to the state in S505. This operation is repeated.

As described above, according to the first embodiment, if the HUB 200 does not support the EEE, the user setting screen shown in FIG. 4 is displayed on the touch panel 115 of the information processing apparatus 100. When the user selects the power saving priority mode on the screen, the communication speed of the PHY 103 of the information processing apparatus 100 is set to 10 Mbps (lowest speed), thereby performing auto negotiation. With this auto negotiation, the information processing apparatus 100 and HUB 200 communicate with each other at a lowest speed of 10 Mbps. As a result, the power consumption of the PHY 103 and MAC 104 can be reduced as compared with a case in which communication is performed at 1 Gbps or 100 Mbps.

To the contrary, if the user selects the communication speed priority mode, the information processing apparatus 100 and HUB 200 can communicate with each other at a settable highest communication speed of 1 Gbps.

In the first embodiment, a case in which the information processing apparatus 100 is set in the power saving priority mode and a case in which communication is performed at 10 Mbps have been explained. However, for example, the communication speed may be set to 100 Mbps instead of 10 Mbps, thereby performing auto negotiation. In this case as well, the power consumption of the PHY 103 and MAC 104 can be reduced as compared with a case in which communication is performed at a communication speed of 1 Gbps.

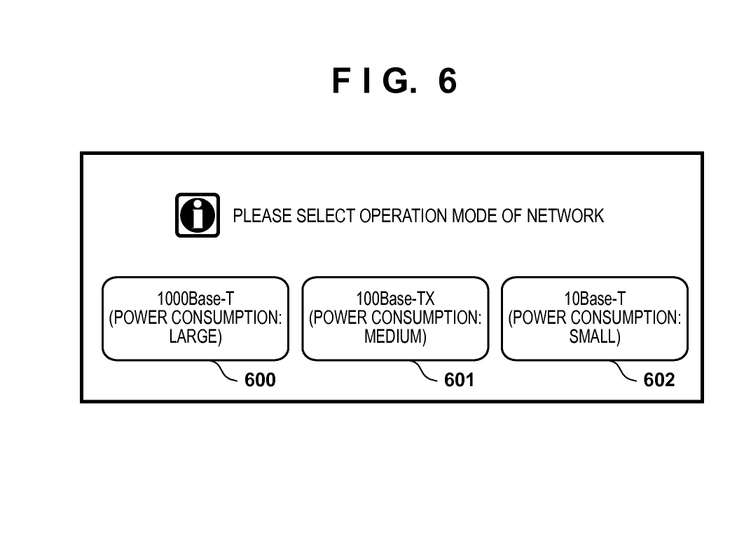

Furthermore, instead of the screen shown in FIG. 4, for example, a screen shown in FIG. 6 may be displayed on the touch panel 115 of the information processing apparatus 100 when the HUB 200 does not support the EEE.

FIG. 6 depicts a view showing an example of a network mode selection screen displayed on the touch panel 115 of the information processing apparatus 100 according to the first embodiment.

This selection screen includes a 1000BASE-T selection button 600, a 100BASE-TX selection button 601, and a 10BASE-T selection button 602. The user can set an arbitrary communication speed by pressing one of the 1000BASE-T selection button 600, 100BASE-TX selection button 601, and 10BASE-T selection button 602. The CPU 108 sets, in the PHY 103, the communication speed selected in this screen and communicates with the HUB 200 at the set communication speed. If the user selects 100BASE-TX or 10BASE-T, the power consumption of the PHY 103 and MAC 104 becomes lower than that when communication is performed at 1 Gbps. Note that 1000BASE-T corresponds to a communication speed of 1 Gbps, 100BASE-TX corresponds to a communication speed of 100 Mbps, and 10BASE-T corresponds to a communication speed of 10 Mbps.

As described above, according to the first embodiment, if the connection partner apparatus as a connection destination does not support the EEE, the operation of the information processing apparatus can be decided according to the operation mode selected by the user. More specifically, if the user sets to prioritize the communication speed, the communication speed is maintained without decreasing the communication speed between the apparatuses. Alternatively, if the user sets to prioritize power saving, negotiation for communication is carried out by decreasing the communication speed. This can reduce the power amount consumed in communication between the apparatuses.

### Second Embodiment

In the above-described first embodiment, in auto negotiation performed between the information processing apparatus 100 and the HUB 200, the information processing apparatus 100 obtains information indicating support/non-support of the EEE of the HUB 200 from the HUB 200, and controls the operation of itself based on the information. To the contrary, in the second embodiment of the present invention, a case in which a user performs predetermined network-related setting in advance will be described. Note that the arrangement of an information processing apparatus and that of a HUB according to the second embodiment are the same as those in the first embodiment and a description thereof will be omitted.

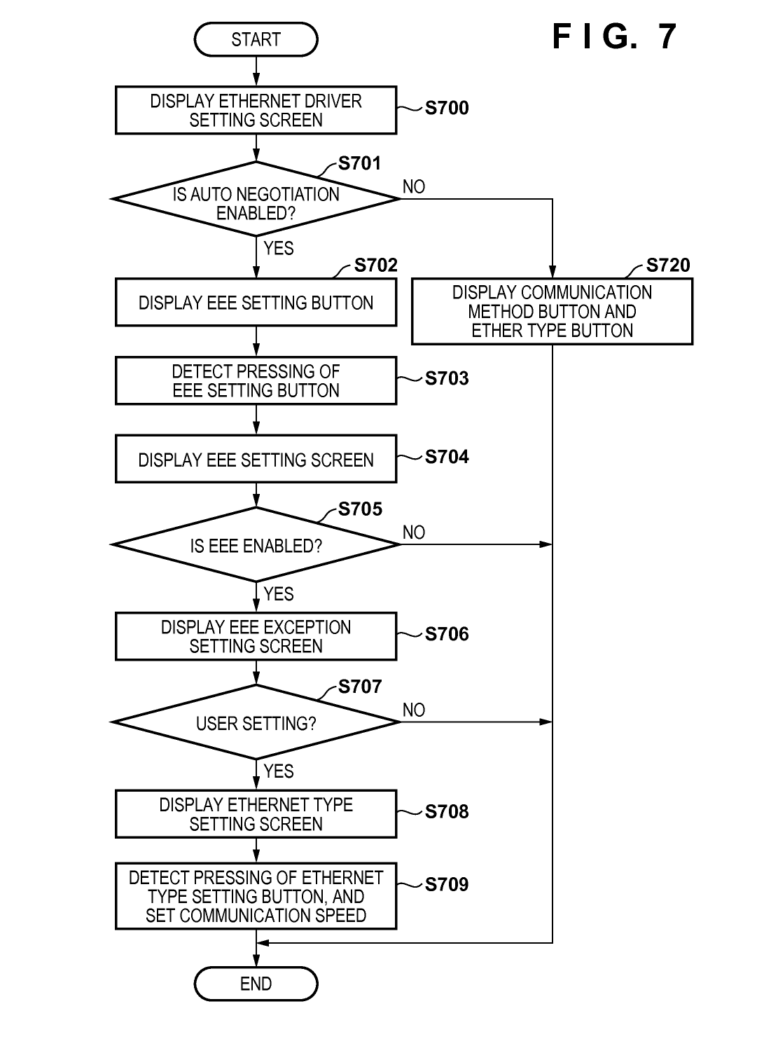

FIG. 7 is a flowchart for describing EEE setting processing by an information processing apparatus 100 according to the second embodiment. Processing in which the information processing apparatus 100 performs EEE-related setting of an Ethernet driver in accordance with a user operation of a touch panel 115 will be explained. Note that processing shown in the flowchart is implemented when a CPU 108 deploys a program stored in a ROM 116 into a RAM 109, and executes it. The information processing apparatus 100 according to the second embodiment includes an Ethernet driver setting as one of various network-related settings. An EEE-related setting will be explained as one of Ethernet driver settings.

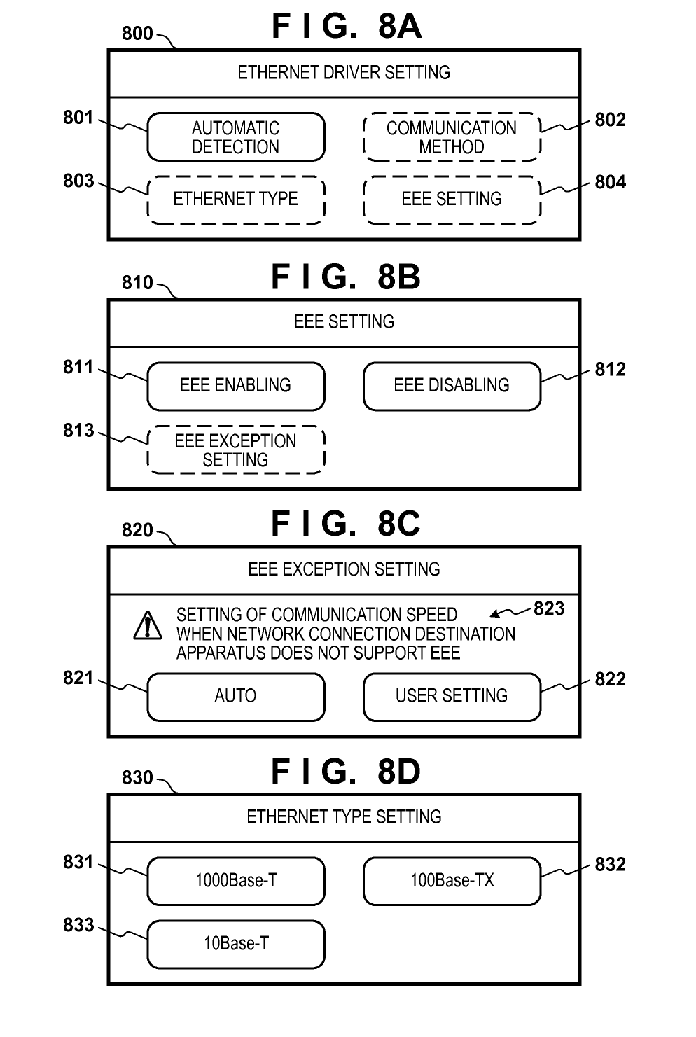

FIGS. 8A to 8D depict views showing various screen examples which are displayed on the touch panel 115 of the information processing apparatus 100 when performing Ethernet driver setting and EEE-related setting.

FIG. 8A shows an Ethernet driver setting screen 800, FIG. 8B shows an EEE setting screen 810, FIG. 8C shows an EEE exception setting screen 820, and FIG. 8D shows an Ethernet type setting screen 830, and a detailed description thereof will be provided later.

Referring to FIG. 7, when the user performs a predetermined input operation by touching the touch panel 115, the CPU 108 detects the input operation, and displays the Ethernet driver setting screen 800 shown in FIG. 8A on the touch panel 115 in step S700. The process advances to step S701, and the CPU 108 determines whether the auto negotiation function of the Ethernet driver is enabled. In the second embodiment, the auto negotiation function is enabled/disabled when the user presses an automatic detection button 801 on the Ethernet driver setting screen 800, and operates via a subsequently displayed screen (not shown). When the auto negotiation function is enabled, neither a communication method button 802 nor an Ethernet type button 803 shown in FIG. 8A is displayed on the Ethernet driver setting screen 800. This is because the communication method and Ethernet type are automatically set by auto negotiation. FIGS. 8A and 8B show, by dotted lines, buttons which may not be displayed as described above. An EEE setting button 804 may not be displayed either, and a detailed description thereof will be provided later.

If it is determined in step S701 that the auto negotiation function is enabled, the process advances to step S702, and the CPU 108 displays the EEE setting button 804 on the Ethernet driver setting screen 800 of the touch panel 115, and advances the process to step S703. On the other hand, if the CPU 108 determines in step S701 that the auto negotiation function is disabled, the process advances to step S720, and the EEE setting button 804 is not displayed. As described above, to implement the function of reducing the power consumption by transiting to the LPI when no network communication is performed for a predetermined time period, it is necessary to send and obtain information indicating support/non-support of the EEE by auto negotiation. When the auto negotiation function is disabled, that is, when no auto negotiation is executed, it is impossible to identify whether the connection partner supports the EEE. Thus, communication is performed in the normal mode in which the power consumption cannot be reduced. In this case, therefore, it is not necessary to perform EEE-related setting, and thus the EEE setting button 804 is not displayed on the Ethernet driver setting screen 800 in step S720. If, therefore, the auto negotiation function is disabled, the process advances to step S720, and the CPU 108 displays the communication method button 802 and the Ethernet type button 803 on the Ethernet driver setting screen 800 of the touch panel 115. This is because the communication method and Ethernet type of the connection partner are not automatically detected, and thus the user needs to set the communication method and Ethernet type. If the auto negotiation function is disabled, the EEE-related setting operation of the Ethernet driver ends after step S720.

On the other hand, if the user presses the EEE setting button 804 displayed in step S702, the process advances to step S703, and the CPU 108 detects pressing of the EEE setting button 804 displayed on the Ethernet driver setting screen 800. The process advances to step S704, and the CPU 108 displays the EEE setting screen 810 shown in FIG. 8B on the touch panel 115. The EEE setting screen 810 includes an EEE enabling button 811, an EEE disabling button 812, and an EEE exception setting button 813. If the user wants to implement the power saving function by causing the information processing apparatus 100 to transit to the LPI, he/she presses the EEE enabling button 811. On the other hand, if the user wants to disable the power saving function of transiting to the LPI, he/she presses the EEE disabling button 812. When the EEE enabling button 811 is pressed to enable the power saving function of transiting to the LPI, the EEE exception setting button 813 is displayed. The EEE exception setting button 813 will be described in detail later. On the other hand, if the EEE disabling button 812 is pressed to disable the power saving function of transiting to the LPI, the EEE exception setting button 813 is not displayed.

The process advances to step S705, and the CPU 108 detects pressing of the EEE enabling button 811 or the EEE disabling button 812 in the EEE setting screen 810, and determines whether the EEE enabling button 811 has been pressed. If it is determined that the EEE enabling button 811 has been pressed, the process advances to step S706, and the CPU 108 displays the EEE exception setting screen 820 shown in FIG. 8C on the touch panel 115. On the other hand, if it is determined that the EEE disabling button 812 has been pressed to disable the EEE, the EEE-related setting operation of the Ethernet driver ends without displaying the EEE exception setting screen 820.

The EEE exception setting screen 820 shown in FIG. 8C includes an auto button 821 and a user setting button 822, and also displays a message 823 for explaining an EEE exception setting. The message 823 for explaining the EEE exception setting describes detailed contents of the EEE exception setting for the user. In the second embodiment, “setting of communication speed when network connection destination apparatus does not support EEE” is displayed. The user can set the communication speed when the apparatus as the network connection destination of the information processing apparatus 100 does not support the EEE by pressing the auto button 821 or user setting button 822. If the user wants to automatically set the communication speed when the connection destination apparatus does not support the EEE, he/she presses the auto button 821. On the other hand, if the user wants to arbitrarily set the communication speed instead of automatically setting it, he/she presses the user setting button 822.

The process advances to step S707, and the CPU 108 detects pressing of the auto button 821 or user setting button 822 in the EEE exception setting screen 820, and determines whether the user setting button 822 has been pressed. If it is determined in step S707 that the user setting button 822 has been pressed, the process advances to step S708, and the CPU 108 displays the Ethernet type setting screen 830 shown in FIG. 8D on the touch panel 115. On the other hand, if it is determined in step S707 that the auto button 821 has been pressed instead of the user setting button, the EEE-related setting operation of the Ethernet driver ends without displaying the Ethernet type setting screen 830.

A 1000BASE-T button 831, a 100BASE-TX button 832, and a 10BASE-T button 833 are displayed in the Ethernet type setting screen 830 shown in FIG. 8D. When the apparatus as the network connection destination of the information processing apparatus 100 does not support the EEE, the user sets the communication speed by pressing one of the 1000BASE-T button 831, 100BASE-TX button 832, and 10BASE-T button 833. In step S709, the CPU 108 detects which one of the 1000BASE-T button 831, 100BASE-TX button 832, and 10BASE-T button 833 of the Ethernet type setting screen 830 has been pressed. The CPU 108 sets the communication speed of the PHY 103 in accordance with the detected button. More specifically, the CPU 108 sets the communication speed to 1 Gbps upon detecting of pressing of the 1000BASE-T button 831, 100 Mbps upon detecting of pressing of the 100BASE-TX button 832, and 10 Mbps upon detecting of pressing of the 10BASE-T button 833. After setting the communication speed in this way, the EEE-related setting operation of the Ethernet driver ends.

The processing when the user performs EEE-related setting of the Ethernet driver of the information processing apparatus 100 by operating the touch panel 115 in the information processing apparatus according to the second embodiment has been explained.

According to this flowchart, the user can enable or disable the EEE setting. When the user enables the EEE setting, if the connection destination apparatus does not support the EEE, it is possible to designate a value to which the communication speed of the PHY is to be set.

The operation of a HUB 200 and the information processing apparatus 100 in which the EEE-related setting of the Ethernet driver has been performed will be described.

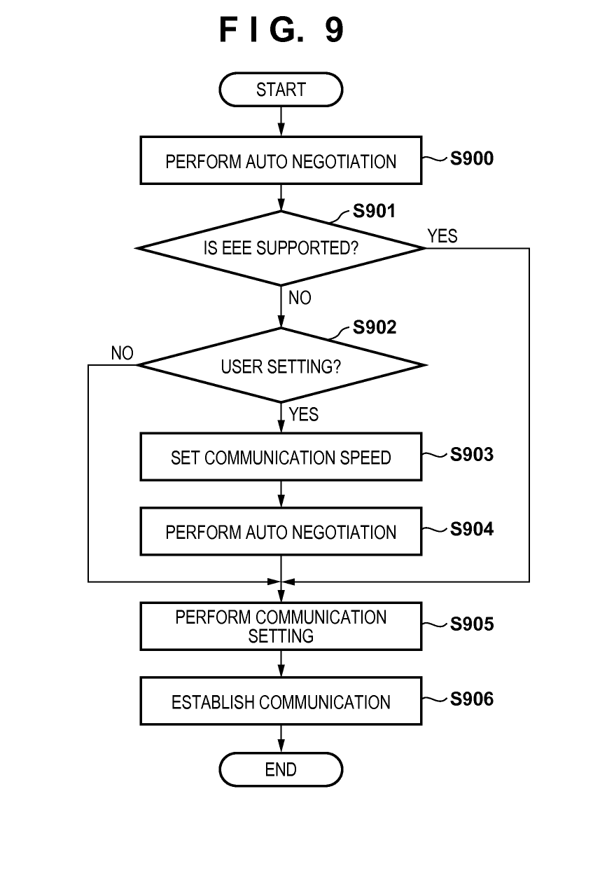

FIG. 9 is a flowchart for describing an operation until the information processing apparatus 100 establishes network communication with the HUB 200 according to the second embodiment. Note that processing shown in the flowchart is implemented when the CPU 108 deploys a program stored in the ROM 116 into the RAM 109, and executes it.

As in the first embodiment, upon start of a network communication establishment operation, the CPU 108 controls the PHY 103 via the MAC 104 to execute auto negotiation in step S900. As in the first embodiment, the communication speed, information about full-duplex/half-duplex, and information indicating support/non-support of the EEE are sent and obtained by the auto negotiation. The process advances to step S901, and the CPU 108 determines whether the HUB 200 as a connection partner supports the EEE, similarly to the first embodiment. An operation when the CPU 108 determines in step S901 that the HUB 200 does not support the EEE will be described. In this case, the process advances to step S902, and the CPU 108 determines whether the communication speed is set by the user when the network connection destination apparatus does not support the EEE. This has been set via the EEE exception setting screen 820 shown in FIG. 8C described above.

If it is determined that the user setting has been selected, the process advances to step S903, and the CPU 108 controls the PHY 103 via the MAC 104 to set the PHY 103 at a predetermined communication speed. The predetermined communication speed in this case is the communication speed set by the user via the Ethernet type setting screen 830 shown in FIG. 8D, which has been described in steps S708 and S709 of FIG. 7. For example, when the user presses the 10BASE-T button 833 in the Ethernet type setting screen 830 shown in FIG. 8D, a setting of a communication speed of 10 Mbps is enabled by disabling valid settings of 1 Gbps and 100 Mbps of the PHY 103, similarly to the first embodiment.

After the setting of the communication speed in step S903, the CPU 108 requests again the HUB 200 to perform auto negotiation in step S904. As in the first embodiment, the communication speed of communication between the information processing apparatus 100 and the HUB 200, and full-duplex/half-duplex are decided by the auto negotiation in step S904. For example, if the communication speed set by the user is 10 Mbps, the communication speed with the HUB 200 is decided as 10 Mbps.

The process advances to step S905, and the CPU 108 performs communication setting of the PHY 103, similarly to the first embodiment. That is, the communication speed, full-duplex/half-duplex, and support/non-support of the EEE which have been decided based on the result of the auto negotiation in step S904 are set in the PHY 103. At this time, the HUB 200 also sets the communication speed and full-duplex/half-duplex which have been decided by the auto negotiation in step S904, similarly to the information processing apparatus 100. The process advances to step S906, and the CPU 108 establishes communication with the HUB 200, thereby terminating the process.

On the other hand, an operation when the CPU 108 determines in step S902 that the communication speed is automatically set instead of being set by the user if the network connection destination apparatus does not support the EEE will be described. The operation in this case is basically the same as that in steps S905 and S906 described above. Note that in the communication setting in step S905, the communication speed decided by the auto negotiation in step S901 is set as the communication speed of the PHY 103. In the second embodiment, by assuming that both the PHY 103 of the information processing apparatus 100 and the PHY 210 of the HUB 200 are operable at a communication speed of 1 Gbps, 100 Mbps, or 10 Mbps, similarly to the first embodiment, the communication speed decided in this step (S905) is the highest speed of 1 Gbps. As a result, the information processing apparatus 100 and HUB 200 establish communication at a communication speed of 1 Gbps.

An operation when the CPU 108 determines in step S901 that the HUB 200 supports the EEE will be explained. The operation in this case is basically the same as that in steps S905 and S906. That is, communication is established at the communication speed decided by the auto negotiation in step S901. Furthermore, since the HUB 200 supports the EEE, when the PHY enters the idle state in which no network communication has been performed for a predetermined time period, transition to the LPI is performed to reduce the power consumption.

As described above, according to the second embodiment, the EEE exception setting button 813 is provided in the EEE setting screen 810 displayed on the touch panel 115 of the information processing apparatus 100, and the user can decide the communication speed when the network connection destination apparatus does not support the EEE. Furthermore, by providing the auto button 821 and the user setting button 822 in the EEE exception setting screen 820, the communication speed when the network connection destination apparatus does not support the EEE can be automatically set or set by the user.

If the user sets the communication speed when the network connection destination apparatus does not support the EEE, the user can set an arbitrary communication speed among 1 Gbps, 100 Mbps, and 10 Mbps. If the HUB 200 does not support the EEE, the information processing apparatus 100 sets the PHY 103 at the communication speed set by the user, thereby performing auto negotiation. If, for example, the communication speed set by the user is 10 Mbps, the information processing apparatus 100 and HUB 200 communicate with each other at 10 Mbps by auto negotiation. As a result, the power consumption of the PHY 103 and MAC 104 of the information processing apparatus 100 can become lower than that when communication is performed at 1 Gbps or 100 Mbps.

Conversely, if the communication speed when the network connection destination apparatus does not support the EEE is automatically set, the information processing apparatus 100 and HUB 200 can communicate with each other at a settable highest communication speed of 1 Gbps.

Furthermore, if the HUB 200 supports the EEE, when the PHY enters the idle state in which no network communication has been performed for a predetermined time period, transition to the LPI can be performed to reduce the power consumption, as in the above-described first embodiment.

### Third Embodiment

In the above-described first embodiment, if the HUB 200 does not support the EEE, the screen shown in FIG. 4 or 6 is displayed on the touch panel 115 of the information processing apparatus 100, and the communication speed of the information processing apparatus 100 is changed according to a button pressed by the user. To the contrary, in the third embodiment of the present invention, if a HUB 200 does not support the EEE, a screen for notifying that the HUB 200 does not support the EEE is displayed on a touch panel 115 of an information processing apparatus 100. Note that the arrangement of the information processing apparatus 100 and that of the HUB 200 according to the third embodiment are the same as those in the above-described first embodiment and a description thereof will be omitted.

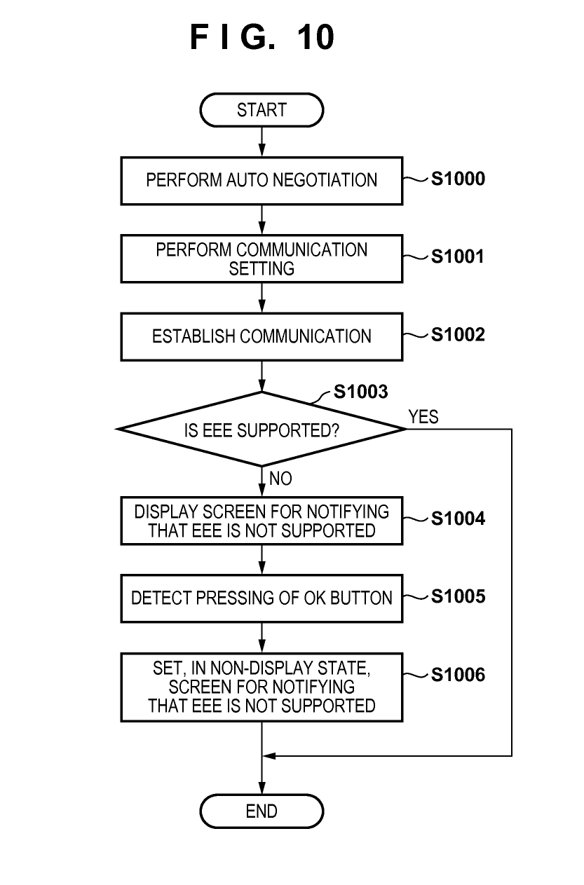

FIG. 10 is a flowchart for describing an operation in which the information processing apparatus 100 establishes network communication with the HUB 200, and notifying that the EEE is not supported according to the third embodiment. Note that this processing is implemented when a CPU 108 deploys a program stored in a ROM 116 into a RAM 109, and executes it.

In step S1000, the CPU 108 starts an operation of establishing network communication to execute auto negotiation, similarly to the first and second embodiments. At this time, the communication speed, information about full-duplex/half-duplex, and information indicating support/non-support of the EEE are sent and obtained by the auto negotiation, similarly to the first and second embodiments. The process advances to step S1001, and the CPU 108 performs communication setting of a PHY 103. The communication speed, full-duplex/half-duplex, and support/non-support of the EEE which have been decided as a result of the auto negotiation in step S1000 are set in the PHY 103. At this time, the HUB 200 also sets the decided communication speed, full-duplex/half-duplex, and support/non-support of the EEE, similarly to the information processing apparatus 100. After that, the process advances to step S1002, and the CPU 108 establishes communication with the HUB 200.

When communication between the information processing apparatus 100 and the HUB 200 is established, the process advances to step S1003, and the CPU 108 determines whether the HUB 200 as a connection partner supports the EEE. If it is determined that the HUB 200 does not support the EEE, the process advances to step S1004, and the CPU 108 displays, on the touch panel 115, the screen for notifying that the network connection destination apparatus does not support the EEE.

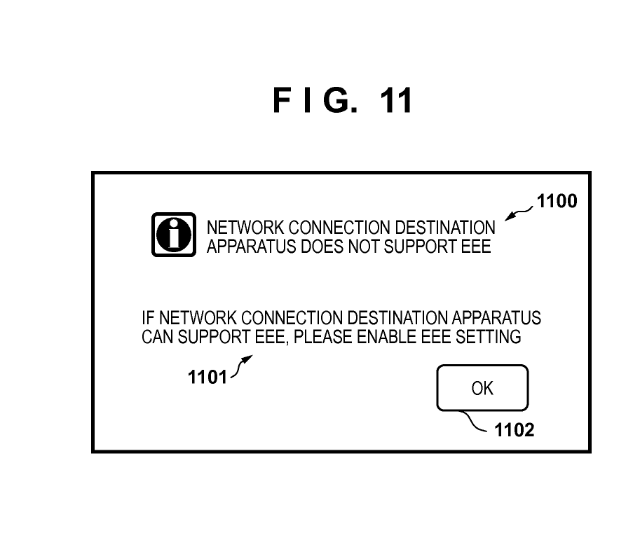

FIG. 11 depicts a view showing an example of the screen for notifying that the network connection destination apparatus does not support the EEE according to the third embodiment.

Referring to FIG. 11, a message 1100 notifies the user that the network connection destination apparatus, that is, the HUB 200 does not support the EEE. This allows the user to recognize that the HUB 200 as a connection destination does not support the EEE. Furthermore, a message 1101 prompts the user to enable the EEE setting when the network connection destination apparatus can support the EEE. An OK button 1102 is provided in the screen for notifying that the network connection destination apparatus does not support the EEE. After confirming these messages, the user presses the OK button 1102.

When the CPU 108 detects in step S1005 that the OK button 1102 has been pressed, the process advances to step S1006, and the CPU 108 sets, in a non-display state, the screen for notifying that the network connection destination (partner) apparatus does not support the EEE.

As described above, according to the third embodiment, if the HUB 200 as a connection destination apparatus does not support the EEE, the screen shown in FIG. 11 is displayed on the touch panel 115, thereby allowing the user to recognize that the connection destination apparatus does not support the EEE.

For example, a network environment is also assumed to be used by disabling the EEE function although the HUB 200 can functionally support the EEE. Consider a case in which a network environment is newly formed by connecting the HUB 200 used in the above environment to the information processing apparatus 100 according to the third embodiment. In this case, the user may not recognize that the EEE function of the HUB 200 is disabled. Alternatively, the user may not even recognize whether the HUB 200 supports the EEE. The third embodiment is effective for such case. The information processing apparatus 100 calls attention to enable the EEE setting by notifying the user that the HUB 200 as a connection destination does not support the EEE. This notification and calling attention enable the user to change the EEE setting of the HUB 200 from the disable state to the enable state. After the change, if the information processing apparatus 100 and HUB 200 establish communication, when network communication enters the above-described idle state, it is possible to transit to the LPI to reduce the power consumption, as a matter of course.

Note that the EEE (LPI method) has been exemplified as an example for implementing the power saving function in the above-described first to third embodiments. The present invention, however, is not limited to the EEE. That is, the present invention is applicable to an apparatus having a function of reducing the power consumption of the network communication unit when no communication has been performed for a given time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-50531, filed Mar. 13, 2014 which is hereby incorporated by reference herein in its entirety.

What is claimed is:

1. An information processing apparatus having a power saving function for reducing power consumption, comprising:
a determination unit configured to determine whether a communication partner apparatus supports the power saving function;
a setting unit configured to, if the determination unit determines that the communication partner apparatus does not support the power saving function, prompt a user to set an operation mode; and
a communication unit configured to perform communication by establishing communication with the communication partner apparatus according to the operation mode set by the setting unit.

2. The apparatus according to claim 1, wherein based on information obtained by negotiation with the communication partner apparatus, the determination unit determines whether the communication partner apparatus supports the power saving function.

3. The apparatus according to claim 1, wherein the operation mode includes an operation mode of prioritizing power saving and an operation mode of prioritizing a communication speed.

4. The apparatus according to claim 3, wherein if the setting unit sets the operation mode of prioritizing power saving, the communication unit performs communication by decreasing a communication speed with the communication partner apparatus.

5. The apparatus according to claim 3, wherein if the setting unit sets the operation mode of prioritizing the communication speed, the communication unit performs communication by setting a communication speed with the communication partner apparatus to a highest communication speed at which communication is possible.

6. The apparatus according to claim 1, wherein the setting unit sets the operation mode by prompting the user to select a communication speed.

7. An information processing apparatus comprising:
a first setting unit configured to prompt a user to enable or disable a power saving function of the information processing apparatus;
a second setting unit configured to, if the power saving function of the information processing apparatus is enabled, prompt the user to set a communication speed when a communication partner apparatus does not support the power saving function; and
a communication unit configured to, if the communication partner apparatus does not support the power saving function, perform communication by establishing communication with the communication partner apparatus according to the communication speed set by the second setting unit.

8. The apparatus according to claim 1, further comprising a display unit configured to, if the communication partner apparatus does not support the power saving function, display information indicating that the communication partner apparatus does not support the power saving function.

9. The apparatus according to claim 8, further comprising a unit configured to, if the communication partner apparatus does not support the power saving function, display information for prompting the user to make a power saving function of the communication partner apparatus effective.

10. The apparatus according to claim 1, wherein the power saving function is a function by an LPI (Low Power Idle) method of an EEE (Energy Efficient Ethernet).

11. A method of controlling an information processing apparatus having a power saving function for reducing power consumption, the method comprising:
determining whether a communication partner apparatus supports the power saving function;
if it is determined in the determining that the communication partner apparatus does not support the power saving function, prompting a user to set an operation mode; and
performing communication by establishing communication with the communication partner apparatus according to the operation mode set by the user.

12. A non-transitory computer-readable storage medium storing a program for causing a computer to execute a method of controlling an information processing apparatus defined in claim 11.
